(19) United States
(12) Patent Application Publication
(10) Pub. No.: US 2015/0134377 A1
(43) Pub. Date: May 14, 2015

(54) SYSTEMS AND METHODS FOR SCHEDULING AND RESERVING SEATS OR SPACES AT GAMING ESTABLISHMENTS

(71) Applicants: Edward Flahive, Norwood, MA (US); Rob Hyland, Canton, MA (US)

(72) Inventors: Edward Flahive, Norwood, MA (US); Rob Hyland, Canton, MA (US)

(21) Appl. No.: 14/540,376

(22) Filed: Nov. 13, 2014

Related U.S. Application Data
(60) Provisional application No. 61/903,944, filed on Nov. 13, 2013.

(51) Int. Cl. G06Q 10/02; G06Q 20/10; G06Q 20/20

(52) U.S. Cl. CPC G06Q 10/02; G06Q 20/209; G06Q 20/10
USPC 705/5

(57) ABSTRACT

The disclosure provides systems and methods for planning and reserving spaces at gaming establishments via one or more communications networks. In various embodiments, the user uses network-capable device to provide data specifying search criteria for a desired gaming session, which may include location, time, and game type desired. The system may serve matching, similar, sponsored, or other results to the user, allowing the user to choose or exclude establishments that match location, time, game type, table stakes, or other criteria of the game. Based on the user's selections, the user may pay to make a reservation, or provide a means of payment to secure the reservation. The system generates a receipt for the user, which may be in any of several forms, including a file or image to print or an electronic receipt for display on a network-capable mobile device.

### CROSS-REFERENCE TO RELATED APPLICATION

The present application claims the benefit of and priority to U.S. Provisional Patent Application No. 61/903,944, filed Nov. 13, 2013, the entire contents of which are incorporated by reference herein.

### BACKGROUND

1. Technical Field

The present disclosure relates systems and methods for reserving seats or spaces using network-capable devices. More specifically, the present disclosure is directed to a computing device network configured to match up providers of services and spaces with potential customers.

2. Background of Related Art

Gaming establishments and other hospitality facilities operate in a competitive marketplace. In order to thrive, these facilities need to attract new customers as well as retain previous customers. One of the ways of accomplishing that goal is by making efficient use of the gaming establishment's space and personnel. Booking tables and games to capacity can lead to better financial results, by bringing in more revenue and by bringing in return customers. Thus, when hospitality facility operators can better anticipate demand at a given time and place, they can staff more appropriately, allowing them to spend efficiently for personnel.

Anticipating and meeting demand also provides for a better customer-centric experience by ensuring sufficient staff is on hand. Resorts and casinos, along with other hospitality facilities, strive to make customers feel welcome and appreciated. Without knowing which customers will be arriving, and what games they wish to play during their visit, it is difficult for the operators of hospitality facilities to reliably service all of their customers. Improvements in customer tracking and booking could help hospitality facilities attract new customers and retain new and existing customers. Improving customer satisfaction may increase the length of stay of the customers, which in turn, increases revenue.

Similarly, customers also have a vested interest in prearranging access to specific locations while vising casinos, resorts, or other gaming. Many individuals plan his/her vacation time or leisure time around a visit to a gaming establishment, often with other guests, and collectively may have limited time to spend at a particular facility. In addition, some visitors may be travelling in family groups, especially as many hospitality facilities offer more than gaming, but not all members of a family group may desire a gaming experience. For those in the group who do wish to have a gaming experience, the ability to plan a time and make a reservation may be a crucial part of a family trip, permitting the gamer to play and also engage in other activities with family members.

Regardless of how or with whom they are travelling, many visitors to gaming establishments want to plan a time or times for gaming, and want to have seats reserved at a table for a game of his/her choice. Visitors may wish to do this at peak times, and may also wish to access premium services when planning a gaming visit and making a reservation.

Thus, there exists a need for an efficient system and method for users seeking a particular gaming experience to make a reservation in advance, including but not limited to the place, date and time, and type of game. Additionally, there is a need for users to be able to arrange space or spaces at tables they wish to play during peak hours and at popular sites, and to access a variety of premium services while at a gaming establishment. Further, there is a need on the part of gaming establishments to efficiently plan staffing, table management and/or game layout.

### SUMMARY

The present disclosure provides systems and methods for reserving seats or spaces that meet user-specified criteria for place, date and time, and game type, e.g., poker, craps, blackjack, and the like. The present disclosure also provides systems and methods for users to reserve one or more seats, permitting users to plan gaming experiences with one or more friends or guests, including the possibility of reserving an entire table. Additionally, users may be able, at certain gaming establishments, to reserve premium services, including but not limited to seats at peak times and places, seat change priority preference, as well as access and use complementary services, and loyalty and rewards program bonuses in making advanced reservations.

Furthermore, the present disclosure provides systems and methods for casinos and other gaming establishments for directing additional traffic and customers to casino locations, by allowing for planning table layout and scheduling dealers and other staff more efficiently.

The system may include a network-capable device to specify the user's desired criteria defining a desired gaming session, which may include location, date and time, and game type desired. The system also includes one or more servers or data centers which communicate with the user's device and one or more participating gaming establishments. The system then provides the results to the user based on the user's query. The system may also provide matching, similar, sponsored, or other results to the user, allowing the user to choose or exclude establishments that match location, time, game type, table stakes, or other criteria of the game. The user may also consider one or more of the sponsored results, even if such a result falls outside of the user's specified criteria for a gaming session.

The system and method according to the present disclose also allows the user to make a selection for a reservation at a particular gaming establishment. The system then communicates that selection to the appropriate one or more gaming establishments. Based on the user's selections, the user may pay to make a reservation and/or provide a method of payment to secure the reservation without being charged. Alternatively, the user may also be allowed to make the reservation without providing a form of payment. The system may also generate a receipt for the user, which may be in any of several forms, including an electronic receipt for display on the user's device. Upon arriving at a gaming establishment selected by a user in advance of a selected gaming session, the user presents the receipt to staff and is directed to the appropriate gaming session.

The system may also bill gaming establishments, by the operator of the system for a commission on each reservation, by any suitable methods within purview of a person of ordinary skill in the art, such as billing as each transaction or reservation occurs or on a rolling basis, e.g., daily, weekly, monthly, etc.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of the system according to an embodiment of the present disclosure; and

FIG. 2 is a schematic diagram of the method according to an embodiment of the present disclosure; and

FIG. 3 is an illustration of a graphical user interface according to an embodiment of the present disclosure.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

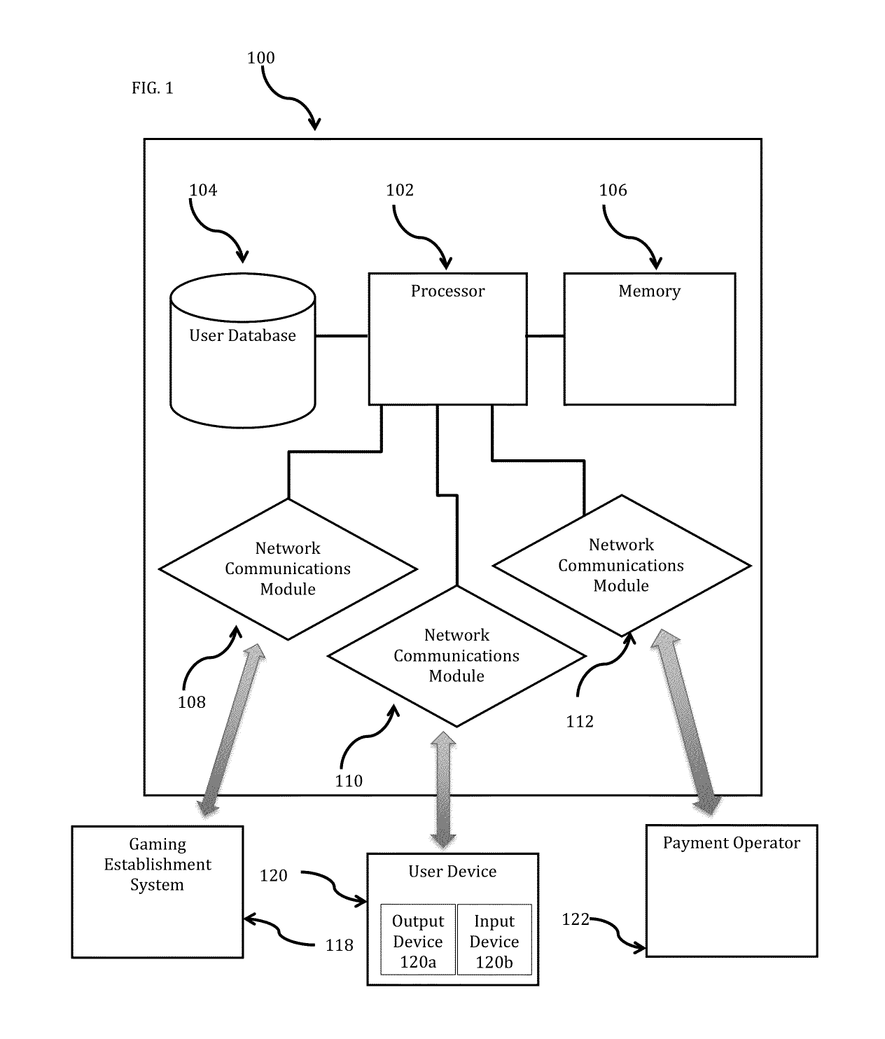

An embodiment of a system 100 of this disclosure is shown in FIG. 1. The system 100 includes a processor 102, a user database 104, a memory 106, a network communications module 108 for communication with one or more gaming establishment systems 118, and a network communications module 110 for communication with one or more user devices 120. In some embodiments, the system 100 includes a network communications module 112 for communication with payment operators 122.

A user may access the system 100 with the user device 120, which may be any device that provides output to, and can receive input from, a user. In embodiments, the user device 120 may be a personal computer, a web-enabled mobile device, a web-enabled kiosk at a gaming establishment or off-site, or other web-capable devices including, but not limited, to televisions, computerized video game systems, and the like.

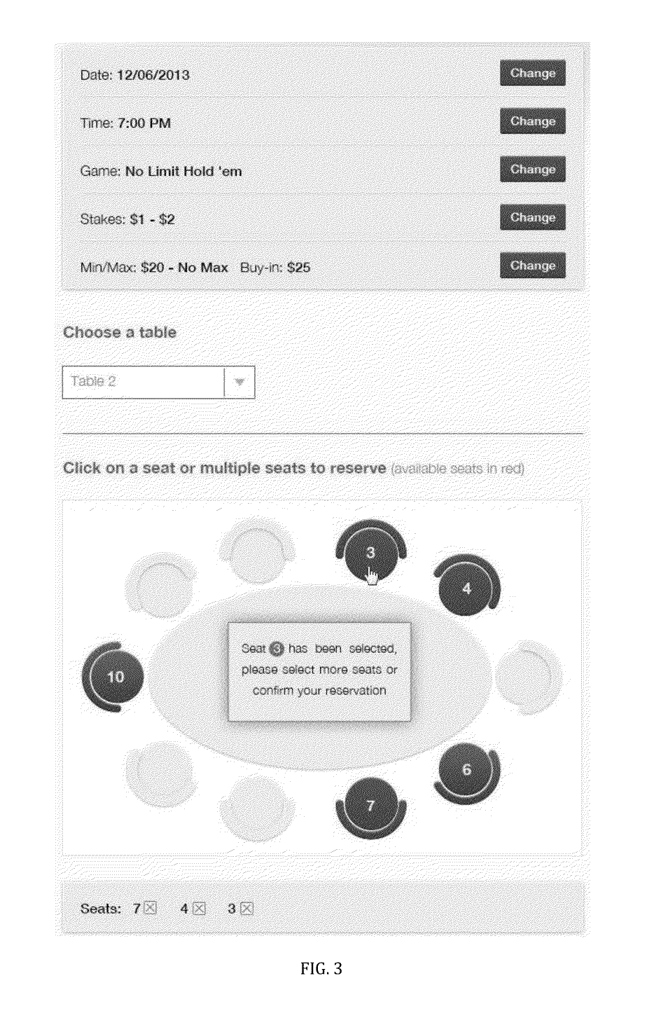

The user device 120 may include an output device 120a, which includes any suitable device operable for displaying information to a user, for example in the form of a graphical user interface (GUI) (FIG. 3). Output device 120a may include, for example, a touch screen, a video display, a printer, a plotter, or other suitable output device. The user device 120 may also include an input device 120b, which includes any suitable device operable to input, select, and/or manipulate various data and information. Input device 120b may include, for example, a touch screen, a keyboard, a mouse, a touchpad, joystick, light pen, microphone, scanner, or other suitable input device.

The memory 106 may include Random Access Memory (RAM) or Read Only Memory (ROM), Electrically Erasable Programmable Read-only Memory (EEPROM), a magnetic disk, flash memory, optical disk, or any other suitable transitory and non-transitory data storage device. Memory 106 may include software or instructions that when executed by the processor 102 cause the processor 102 to perform any of the methods described herein. Examples of the instructions may include a “thick client”, i.e., a networked computer with most resources installed locally, rather than distributed over a network, such as a native application that runs on the user device 120, receives data from the gaming establishment systems 118 and/or the payment operators 122 and conducts its own processing and data manipulation. Alternatively, the instructions may be a “thin client” interface, i.e., a networked computer that depends heavily on a server to fulfill its computational roles, enabling display of data received from the gaming establishment systems 118 and/or the payment operators 122, and all processing and data manipulation occurs at the system 100 and is made available via a browser such as, for example: Mozilla® (Firefox®), Internet Explorer®, Google Chrome®, Safari® or any other current or future browsers. Memory 106 may include any computer memory (e.g., RAM or ROM), mass storage media (e.g., a hard disk), removable storage media (e.g., a Compact Disk (CD), a Digital Video Disk (DVD), or USB Flash Drive), database and/or network storage (e.g., a server), or any combination thereof.

Processor 102 may include any suitable device operable to execute instructions and manipulate data to perform operations. Processor 102 may include any type of central processing unit (CPU) such as those available from Intel®, AMD®, TI®, Qualcomm®, or any other logic controller.

Network communications modules 108, 110, and 112 may includes any suitable device operable to receive input, send output, perform suitable processing of the input or output or both, communicate to other devices, such user device 120, the gaming establishment systems 118 and/or the payment operators 122, or any combination thereof. Network communications modules 108, 110, and 112 may include appropriate hardware (such as a modem, network interface card, etc.) and software, including protocol conversion and data processing capabilities, to communicate through a local area network (LAN), wide area network (WAN) employing one or more of wired or wireless connections.

The term “wireless connection” as used herein includes any of a plurality of communications standards, protocols and technologies, including but not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS), and/or Short Message Service (SMS)), or any other suitable communication protocol, including communication protocols not yet developed as of the filing date of this disclosure, and combinations thereof.

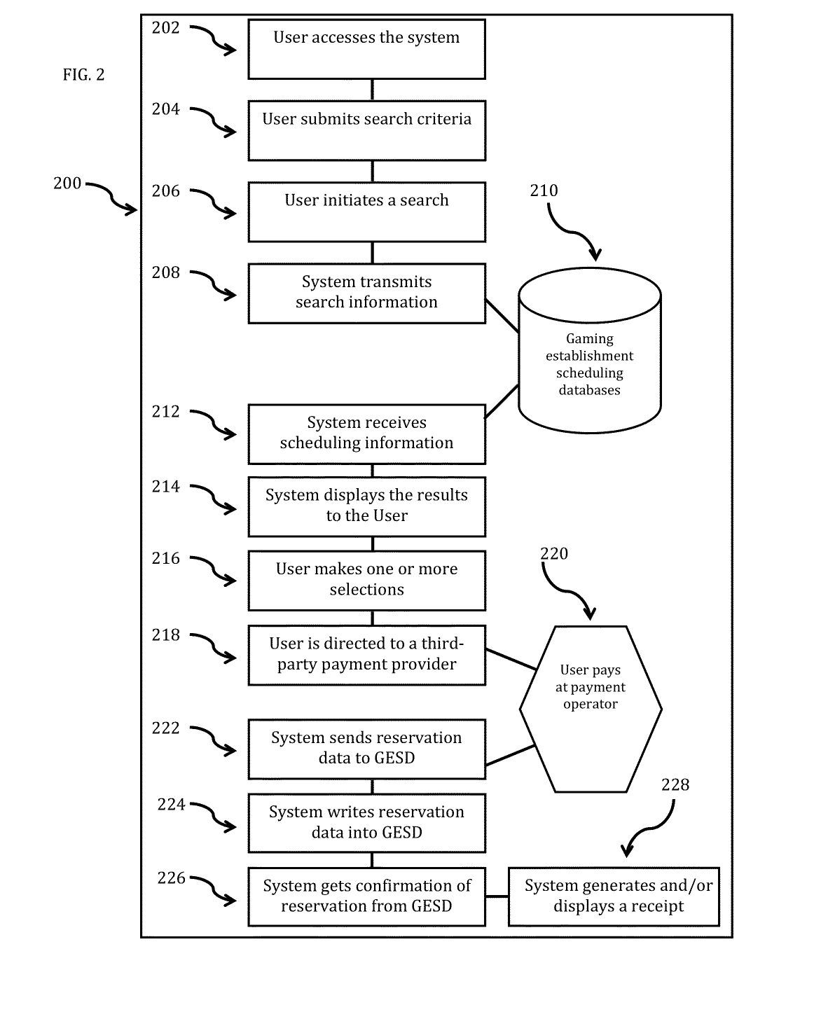

A method according to the present disclosure is illustrated in FIG. 2. Following the method 200 of the present disclosure, a user accesses the system 100 at step 202, submits search criteria at step 204 for a search, which may be stored in the user database 104, and initiates a search at step 206. A user may access the system and service without registering, in embodiments, the user may register with the system 100, storing user information and preferences in the user database 104.

Once the search criteria has been submitted, the system 100 transmits search information at step 208 to gaming establishment scheduling databases (“GESD”) 210, receives scheduling information at step 212 from GESD, and displays the results at step 214 to the user. The user then uses the system 100 to make one or more selections at step 216.

After the remaining selections are confirmed by the user, the system 100 then directs the user 218 to the payment operator 122 at step 220. Upon notification to the system 100 of successful completion of the payment at the payment operator 120, the system 100 sends data 222 to the GESD 210, and the system 100 writes reservation data 224 directly into the GESD 210, creating the user's desired reservation or reservations. The system 100 then obtains confirmation 226 of each reservation from the GESD 210, and the system 100 then generates and/or displays a receipt 228 for the user.

FIG. 3 illustrates a graphical user interface of the user device 120 illustrating a plurality of menus, options, for searching and selecting a game. Suitable inputs, include, but are not limited to, date, time, gaming establishment, game type, stakes, and other search criteria.

As described above, the user submits search criteria at step 204 specifying the search he wishes to run, including but not limited to location information, date and time information, information on the game type sought by the user, and information on the number of seats sought by the user. In some embodiments the user also submits search criteria at step 204 indicating that he or she would like to access premium services, which may include reserving a “seat change” button, which allows the user to change seats when an open seat becomes available at the gaming table during play. Registered users who have created one or more preset lists of preferences, stored in a user database 104, may, after accessing the system 100 at step 202, access and select one or more of their pre-set preferences stored in a user database 104 to fill in one or more of the categories of search criteria 204.

The location information may include one or more particular gaming establishments or casinos, or may be a place as specified by one or more of a city, a state, a ZIP code, and a distance therefrom to search. In some embodiments, the system 100 may present to a user groupings of gaming establishments, each grouping comprising one or more gaming establishments, which may be based on any factors, including but not limited to the geographic location of the user, as determined by one or more of internet protocol routing information, access to device location through a mobile application on a mobile device, location of a kiosk, or user-specified preferences. The system 100 may also present one or more gaming establishments as sponsored results.

The date and time information may be a particular moment, or may include a range of dates and/or a range of times on one or more of those dates. The game type information may include information on the variety of games to be played at that table, information on the table stakes such as whether there is a buy-in, ante, or table limits, or information on the number of players a table may accommodate. The information on the number of seats the user seeks to reserve, in the search at hand, may be a certain number or may span a range of seats.

After submitting search criteria at step 204 for a search, the user initiates a search at step 206, such as by clicking or selecting a button, or other means of indicating to the system 100 that it should initiate the search. The system 100 then transmits information at step 208 to one or more GESDs 210, which independently process the user's search criteria at step 204 and locate matching results. The one or more GESDs 210 then transmit those matching results to the system 100 as scheduling information, which receives the scheduling information 212. In embodiments, that scheduling information from the GESD 210 includes information on how many seats, and which seats, are available at specified tables.

With reference to FIG. 3, the user may also select a particular table and seats once the other search criteria are confirmed by the gaming establishment systems 118, e.g., requested table is available and has the requested number of seats. The selection may display available seats at the gaming table and may indicate to the user which seats have been selected by the user.

The system 100 displays the results at step 214 to the user, and provides the user with means to make one or more selections at step 216. This may be done, in embodiments of the disclosure, in a graphical list view, with logos or other symbols of the gaming establishments. The user selections at step 216 may also be made from a text-based list. In embodiments, the system 100 may display a graphical representation of the table or tables for which results were returned, allowing users to select a particular seat or seats, in some embodiments at additional cost. When making his or her selections at step 216, the user may also opt for premium services, including but not limited to choosing the “seat-change button” or signifier at the user's chosen gaming establishment for a seat change priority preference, concierge services, loyalty and rewards program bonuses, or complementary services, offers, or gifts. Additionally, users may be able, at certain gaming establishments, to reserve seats at peak or more desirable combinations of place, time, and game type, in some embodiments for additional cost.

For users who are registered with the system 100 and have set preferences in the user database 104 regarding displaying results, the system 100 may display the results at step 214 from matching GESDs 210 in accord with the user's preferences. If no relevant user preferences exist in the user database 104, the system 100 displays results at step 214 following the default values for displaying search results, which may include consideration of closeness of match to the user's search criteria at step 204, sponsorship of search results in the display of results at step 214 by gaming establishments, or other factors. The system 100 may provide matching, similar, sponsored, or other results to the user, even if such a result falls outside of the user's specified criteria at step 204 for a gaming session. In embodiments, additional advantages of registration as a paid registered user include the option to reserve a certain number of seats per month or other time period, at reduced or no cost.

The user may then make one or more selections at step 216, which may be one or more seats at one or more times for one or more game types, and which may also include premium services. In embodiments, the user may reserve a block of seats, up to and including an entire table, if available, permitting users to plan gaming experiences with one or more friends or guests.

The system 100 then directs the user to the payment operator 122 at step 218. The payment operator 122 may include a website or the system 100 may frame functionalities of the payment operator 120 while keeping the user at the interface of the system 100. In embodiments, the system 100 may collect, store, and process for payment the user's payment information, using the user database 104 and the communications module 108. In some embodiments, the user may pay or provide payment information for the system to send reservation data to the GESD 210 at step 222. In other embodiments, the system may send reservation data to the GESD 210 at step 222 without a user providing a form of payment for reasons which may include but are not limited to pre-payment in the user's account registered with the system 100, elite status of the user with a registered account, and/or prior agreements with gaming establishments for payment of reservations booked using the system 100.

Upon successful completion of the payment and confirmation to the system 100, the system 100 sends reservation data at step 222 to the GESDs 210, creating the reservation or reservations. In embodiments, the system 100 writes the reservation data 224 directly into the GESD 210. Such data contains the user selections 216 for place, time, game type, and premium services, if any, for the user's one or more desired reservations. The system 100 confirms 226 with the GESDs 210 that the reservation or reservations have been created, and then uses that confirmation, which in embodiments, may include a unique confirmation code and/or generate a receipt for the user at step 228. The user's receipt may specify the gaming establishment, date, time, table, seat or seats, game type, and any premium services that the user requested and paid for. The receipt may take the form of a ticket and may include any image, text, or unique confirmation code, which the user may present to the gaming establishment. The receipt may also be in the form of a text message alert, an email, or a graphic, bar code, QR code, or other suitable computer-readable or unique text information which can be displayed on a mobile application (e.g., on the user device 120) or printed or displayed by other means. In embodiments, only registered users have access to all modes of receiving and presenting their unique confirmation code. In further embodiments, registered users may be able to log in to their accounts to access information on their current and past reservations, including place, time, game type, premium services, and payment information.

In some embodiments of the disclosure, the user may arrive at the gaming establishment a specified amount of time before his/her time of reservation in order to be assured of having the reservation guaranteed by the gaming establishment—this information may be clearly presented to the user during the selection process of step 216 and payment process of step 220, and may also be stated on the receipt. Such an early-arrival period may be settable by the gaming establishments to ensure efficient operation. Similarly, a user may be allowed to make a reservation only in advance of the then-present time. In embodiments of the disclosure, such an advance-reservation period may be four hours. In some embodiments of the disclosure, a user may be able to make a reservation only to begin on the hour or half-hour, e.g. at 12:00, 12:30, 1:00, etc.

The various modules described above may be implemented by computer-executable instructions, such as program modules, executed by a conventional computer. Generally, program modules include routines, programs, objects, components, data structures, etc. that performs particular tasks or implement particular abstract data types. Those skilled in the art will appreciate that the disclosure may be practiced with various computer system configurations, including hand-held wireless devices such as mobile phones or PDAs, multiprocessor systems, microprocessor-based or programmable consumer electronics, minicomputers, mainframe computers, and the like. The disclosure may also be practiced in distributed computing environments where tasks are performed by remote processing devices that are linked through a communications network. In a distributed computing environment, program modules may be located in both local and remote computer-storage media including memory storage devices.

The central computing device may include or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, RUM and/or JavaScript for example. Further, it is not necessary that a single type of instruction or programming language be utilized in conjunction with the operation of the system and method of the disclosure. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the disclosure.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present disclosure were described above. From the foregoing it will be seen that this disclosure is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present disclosure is not limited to those embodiments described above, but rather the intention is that additions and modifications to what was expressly described herein are also included within the scope of the disclosure. Moreover, it is to be understood that the features of the various embodiments described herein are not mutually exclusive and can exist in various combinations and permutations, even if such combinations or permutations were not made express herein, without departing from the spirit and scope of the disclosure. In fact, variations, modifications, and other implementations of what was described herein will occur to those of ordinary skill in the art without departing from the spirit and the scope of the disclosure. As such, the disclosure is not to be defined only by the preceding illustrative description.

What is claimed is:

1. A method for reserving a gaming session, comprising:
receiving a user request for a gaming reservation from a user device, the request including at least one criteria;
transmitting at least one gaming reservation matching the at least one criteria to the user device in response to the user request;
receiving a selected gaming reservation from the user device; and
updating a scheduling database to schedule a gaming session based on the selected gaming reservation.

2. The method according to claim 1, wherein the at least one criteria is selected from the group consisting of game type, location, time, minimum bet, maximum bet, stakes, and combinations thereof.

3. The method according to claim 1, wherein transmitting the at least one gaming reservation further includes transmitting a seat map associated with the at least one gaming reservation to the user device.

4. The method according to claim 3, wherein the selected gaming reservation includes at least one selected seat on the seat map.

5. The method according to claim 4, further comprising indicating the at least one selected seat on the seat map.

6. The method according to claim 1, further comprising:
receiving electronic payment for the at least one gaming reservation.

7. The method according to claim 1, further comprising:
generating a receipt for the at least one gaming reservation.

8. A system for reserving a gaming session, comprising:
a database;
a processor; and
a memory storing instructions executable by the processor, wherein the instructions when executed by the processor cause the processor to:
receive a user request for a gaming reservation from a user device, the request including at least one criteria;
transmit at least one gaming reservation matching the at least one criteria to the user device in response to the user request;
receive a selected gaming reservation from the user device; and
update the database to schedule a gaming session based on the selected gaming reservation.

9. The system according to claim 8, wherein the database includes a plurality of user profiles.

10. The system according to claim 9, wherein each of the plurality of user profiles includes the at least one criteria.

11. The system according to claim 9, wherein the at least one criteria is selected from the group consisting of game type, location, time, minimum bet, maximum bet, stakes, and combinations thereof.

12. The system according to claim 9, wherein the at least one gaming reservation includes a seat map.

13. The system according to claim 12, wherein the selected gaming reservation includes at least one selected seat on the seat map.

14. A device for reserving a gaming session, comprising:
a processor; and
a memory storing instructions executable by the processor, wherein the instructions when executed by the processor cause the processor to:
generate a user request for a gaming reservation from a user device, the request including at least one criteria;
receive at least one gaming reservation matching the at least one criteria in response to the user request;
select a desired gaming reservation from the at least one gaming reservation; and
transmit the selected gaming reservation to a scheduling database to schedule a gaming session based on the selected gaming reservation.

15. The device according to claim 14, wherein the device includes an output device and an input device.

16. The device according to claim 15, wherein the output device is configured to display a graphical user interface and the input device is configured to interact with the graphical user interface.

17. The device according to claim 16, wherein the graphical user interface is configured to display a seat map associated with the at least one gaming reservation.

18. The device according to claim 1, wherein the at least one criteria is selected from the group consisting of game type, location, time, minimum bet, maximum bet, stakes, and combinations thereof.
